(19) United States
(12) Patent Application Publication
(10) Pub. No.: US 2003/0037596 A1
(43) Pub. Date: Feb. 27, 2003

(54) Leakage detection system for gas pipelines

(76) Inventor: Peter K. Sorensen, Gronnevej (DK)

Correspondence Address: STEINBERG & RASKIN, P.C., 1140 AVENUE OF THE AMERICAS, 15th FLOOR, NEW YORK, NY, 10036-5803, US

(21) Appl. No.: 09/894,263

(22) Filed: Jun. 28, 2001

(51) Int. Cl. G01M 3/04

(52) U.S. Cl. 73/40.7

(57) ABSTRACT

An integrated pipeline and gas leak detection system including:

a. an integrated section formed of

a. a carrier pipe;

b. a tubular outer jacket surrounding the carrier pipe with an annular space between the outer jacket and the carrier pipe;

c. a gas leak detection pipe (“Sniffer pipe”) situated in the annular space generally parallel to the carrier pipe, the Sniffer pipe having a plurality of holes extending radially through its walls and axially spaced from each other, and

d. thermal insulation material in the annular space and surrounding the Sniffer pipe, with opposite ends of the annular space closed.

b. a suction device coupled to one end of the Sniffer pipe, the other end of the Sniffer pipe being closed, and pipe being closed, and

c. a gas detection device situated between the suction device and the Sniffer pipe, whereby operation of the suction device sucks any gas leaked from the carrier pipe in through the apertures in the Sniffer pipe, then through the Sniffer pipe to the gas detector which detects the presence of the leaked gas.

### FIELD OF THE INVENTION

This invention relates to detection systems for gas leakage from pipelines, and more particularly to methods and apparatus for detecting gas leakage from a thermally insulated gas pipeline.

### BACKGROUND OF THE INVENTION

It is well known that leaks in gas pipelines can be both expensive and dangerous. In such pipelines detection and location of leaks needs to be done quickly and efficiently, and efforts to handle this problem have included numerous and diverse approaches, some examples being set forth as follows.

U.S. Pat. Nos. 4,455,863 and 4,785,659 disclose methods for locating gas leaks in underground pipes by detection of sound waves created by the leaking gas. Two obvious limitations of this method are that a great many sound transducers are required to monitor a long-distance pipeline, and that such system must include circuitry along its full length coupled to all the sound transducers. Furthermore, this system may be inappropriate and not sufficiently sensitive for certain kinds of gas leaks.

U.S. Pat. No. 3,992,923 discloses a system to detect gas leaks in underwater pipelines by moving a transmitter and receiver of ultrasonic pulses externally of the pipe and detecting the pulses reflected by leaking gas bubbles.

In U.S. Pat. No. 4,543,481 samples of natural gas leaked from a pipeline are detected by an airborne radiometer conveyed along the route of the pipeline.

U.S. Pat. Nos. 4,651,559 and 5,866,802 disclose detection of leaks in a gas pipeline by measuring the gas pressure gradient in each of the upstream and downstream parts of the gas line. For long distance pipelines this method has various limitations, including the difficulty to accurately measure the pressure gradients and the possibility that such pressure gradients have a cause other than gas leakage.

U.S. Pat. No. 4,727,748 discloses a gas leak detection method which measures and compares inflow and outflow rates in a gas pipeline. This method has limitations similar to those of the prior patent, U.S. Pat. No. 4,651,559, in addition to the expense and complexity of apparatus required.

The present invention is totally different from all the above-described prior art disclosures, is simpler, less expensive and often more reliable, as set forth below.

### SUMMARY OF THE INVENTION

The present invention is a method and apparatus for detecting leaks in gas pipelines, and particularly in pipelines of the type comprising a carrier pipe surrounded by a layer of thermal insulation and an outer jacket. It is applicable to pipelines of various lengths, and especially to pipelines where a leak may occur in a remote or inaccessible location.

According to the present invention a gas leak detection pipe, also called “Sniffer pipe”, extends axially within the insulation material surrounding the carrier pipe for whatever length of pipe that is to be monitored for a gas leak. The Sniffer pipe lies generally parallel and adjacent to the carrier pipe, and the Sniffer pipe walls are perforated by generally radially extending holes distributed and spaced apart axially along its length, or at least along the portion of its length that corresponds to and is adjacent the carrier pipe to be monitored. For clarity and convenience of terminology herein, a length of prior art insulated pipe will be called “insulated pipe section”, a length of such insulated pipe section with the Sniffer pipe included and combined therewith will usually be called “integrated pipe section”, and joined integrated pipe sections will be called “integrated pipeline”.

Either constantly or at selected time intervals, suction is applied by a vacuum pump or other pressure means to one end of the Sniffer pipe. Any gas that has leaked from the carrier pipe is drawn through the radial holes in the Sniffer pipe walls and then through the bore of this pipe. In a preferred embodiment the outer jacket surrounds the carrier pipe, defining an annular space between this jacket and carrier pipe, and in this annular space is situated the Sniffer pipe and foamed thermal insulation material.

At least one gas detector is situated between the Sniffer pipe and the vacuum pump to determine the presence or absence of leaked gas from the carrier pipe. Appropriate action is taken when a leak is detected.

It is an object of this invention to provide a gas leakage detection method and apparatus for a gas conveyance or gas pipeline system which is simple, reliable and economically feasible.

It is a further object of this invention to provide a gas conveyance and gas leak detection system which is integrated such the joining of sections or lengths of gas conveyance or carrier pipe will automatically establish the gas leak detection system in place. This is in contrast to traditional arrangements where gas leak detection devices are structurally independent of and/or remote from the carrier pipe.

Accordingly, it as a further object of this invention to incorporate the gas leak detection pipe (Sniffer pipe) into the typical insulated section, and specifically into the insulation layer situated in the annular space between the outer jacket and the inner carrier pipe. Any gas leaked from the carrier pipe can percolate through the insulation material, then through the apertures in the Sniffer pipe walls, and thence into the bore of the Sniffer pipe. A vacuum pump or other appropriate pressure reduction means creates suction to draw any leaked gas through the Sniffer pipe to a gas detector which provides an appropriate signal for the presence of leaked gas.

When integrated pipe sections are joined end-to-end, the adjacent ends of carrier pipe are welded together, and the ends of Sniffer pipe are appropriately joined, thus forming parallel carrier pipe and Sniffer pipe conduits.

In operation, the carrier pipe is monitored for leakage by merely applying suction to the Sniffer pipe component. This achieves leak detection without the typical prior art complications and expenses of ultrasonic, optical, pressure or other monitors and of the related subsystems to operate these monitors.

### BRIEF DESCRIPTION OF THE DRAWINGS

FIG. 1 is a schematic elevation view of the new invention including the new integrated pipeline, a gas detector and a vacuum pump;

FIG. 2 is a schematic elevation view of one integrated pipe section the pipeline of FIG. 1;

FIG. 3 is a sectional view taken along line 3-3 in FIG. 2;

FIG. 4 is a fragmentary perspective view of a length of gas leakage detection pipe;

FIG. 5 is an end view of the pipe FIG. 4;

FIG. 6 is an end view similar to FIG. 5, showing another embodiment;

FIG. 7 is a sectional view similar to FIG. 3 of an alternate inverted version of the gas leakage detection pipe; and

FIG. 8 is a fragmentary schematic elevation view of a junction of two integrated pipe sections.

### DETAILED DESCRIPTION OF THE PREFERRED EMBODIMENTS

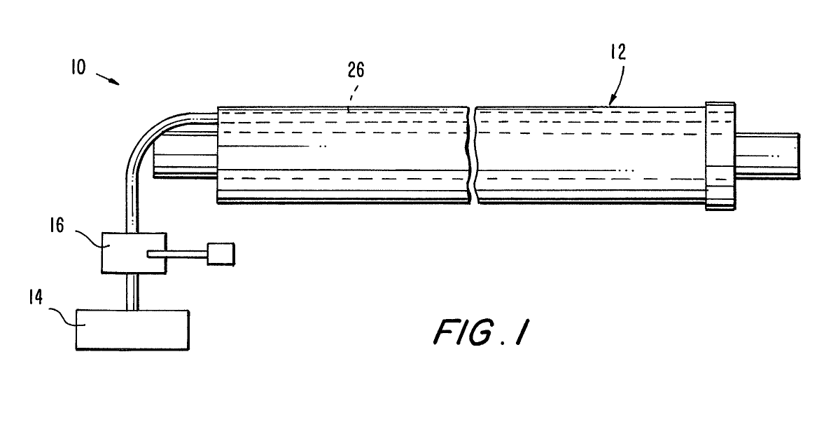

FIG. 1 shows the new gas pipeline and gas leakage detection system 10 of this invention which includes the pipeline 12 of joined integrated pipe sections 13, vacuum pump 14, and gas detector 16. Each integrated pipe section 13 includes a length of carrier or gas conveyance pipe and a length of Sniffer pipe.

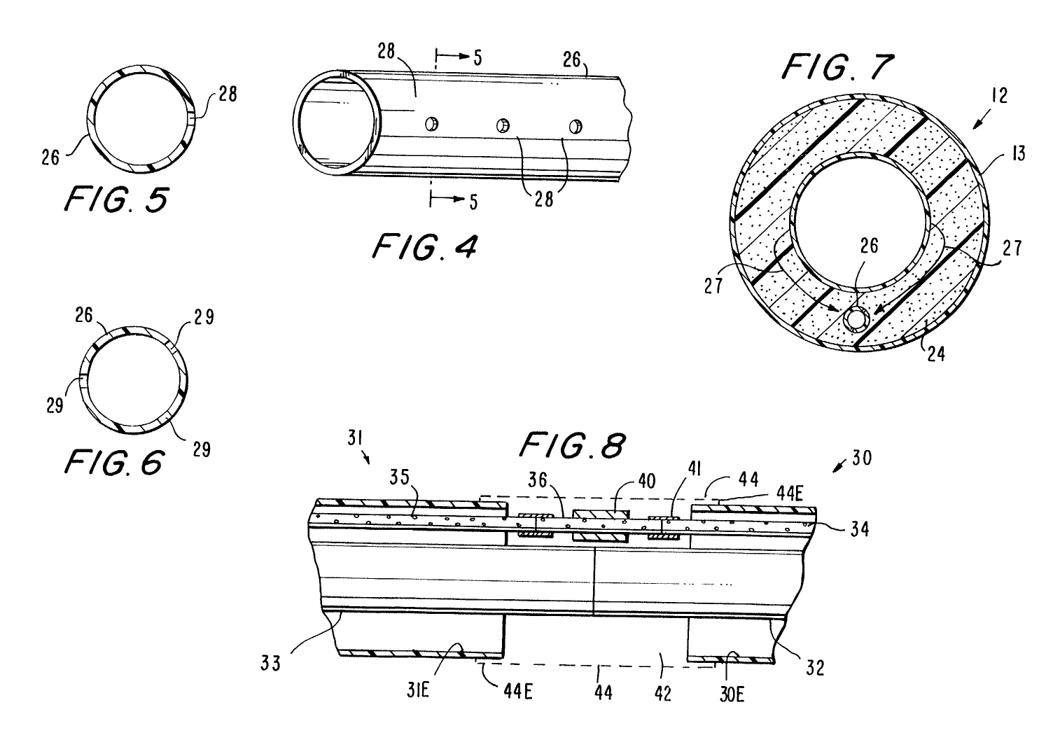

The typical integrated pipe section 13, as seen in the FIG. 3 cross-sectional view, comprises a central carrier pipe 18 of radius R₁ in the range of about 10 mm to 610 mm and made of any typical pipe material, an outer jacket 20 made of high density polyethylene (HDP) and having radius R₂ in the range of about 30 mm to 700 mm, with an annular space 22 between them which space is filled with foamed-in thermal insulation material 24 such as polyurethane. This annular space 22 has thickness equal to (R₁ minus R₂), and within this annular space is a Sniffer pipe 26 made of cross-linked polyethylene (PEX) or similar polymer pipe and perforated along its length with holes 28 extending radially through its wall, as seen in FIG. 4. The distribution or density and size of these holes depends on the permeability of the gas leaked from the carrier pipe to be detected. In one embodiment of FIG. 4 and 5, the holes have a diameter of about 2 mm to 4 mm and are spaced at about 10 mm to 150 mm apart in the axial direction substantially in line along a surface facing the carrier pipe. FIG. 5 shows how these holes 29 may be distributed around the circumference in addition to being distributed lengthwise. One preferred distribution pattern is 10 mm to 150 mm in axial distance between holes and 90° in circumferential distance between each two adjacent holes. Thus, there would be axially spaced sets of holes, where each set comprises four circumferentially spaced holes.

The Sniffer pipe has diameter D_{S} which is less than the thickness t, and thus easily fits in the annular space 22. Diameter D_{S} is preferably in the range of 10 mm to 40 mm.

In the integrated pipeline 12 of FIG. 3, the Sniffer pipe 26 is situated in the upper portion of the insulation layer 24 in anticipation of leakage of a relatively light gas which would percolate upward in the system as indicated by arrows 25. FIG. 7 shows a similar integrated pipeline 12 with the Sniffer pipe 26 situated in the lower portion of the insulation layer 24 in anticipation of leakage of relatively heavy gas which would percolate downward in the system as indicated by arrows 27.

Integrated pipe sections, commonly up to twenty-four meters in length, are joined end-to-end to a selected total length, as will be described below; however, before such junction, each length is tested to verify that the perforations of the Sniffer pipe are properly open. Such testing is necessary because in the manufacture of each pipe section, the insulation material is foamed-in, totally surrounding the Sniffer pipe. To prevent blockage of the perforations, the length of Sniffer pipe is surrounded by a tight layer of open-celled high density polyethylene (HDPE) foil of thickness in the range of 0.2 mm to 5 mm which should ensure that the foamed-in insulation material does not enter or clog the perforations in the Sniffer pipe wall. This foil remains after the pipe assembly is manufactured, and does not interfere with the Sniffer pipe's function because the leaked gas being detected will penetrate this foil by diffusion.

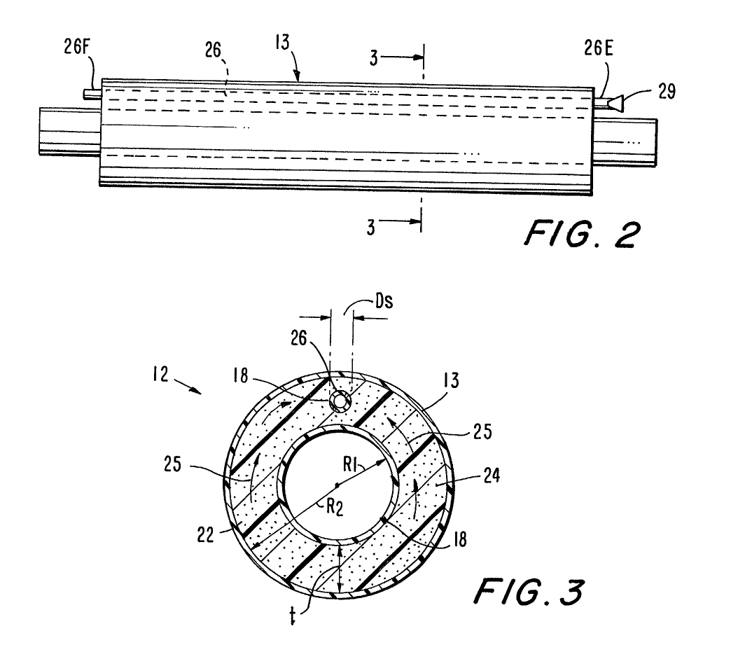

A procedure to verify that the perforations in a single length of pipe assembly are adequately open, is shown schematically in FIG. 2 where the Sniffer pipe 26 is sealed at one end 26E with a plug 29, and air pressure of about 6-8 bar is “shot” into the other end 26F. If the pressure drops to about 3 to 4 bars the perforations are considered properly open.

The procedure for joining adjacent ends of two such integrated sections 30,31 is shown in FIG. 8. Adjacent ends of carrier pipe 32 and carrier pipe 33 are welded according to standard techniques appropriate for the steel composition of these pipes. Sniffer pipes 34 and 35 of PEX or similar polymer pipes are joined by inclusion of intermediate connection pipe 36, with a shrinkable joint with hot melt adhesive inside around the junction and heat shrunk into a gas-tight seal. The intermediate portion 40 of the connection pipe 36 is wrapped in the HDPE foil 41 as earlier described to protect its perforations from the foam, and then the entire annular space 42 is surrounded by protective outer jacket indicated by dotted lines 44, and filled with insulation foam. The ends 44E of the outer jacket are sealed at the ends 30E and 31E of the two integrated sections being joined.

In operation of the system of FIG. 1, the vacuum pump 14 is periodically actuated, which creates a negative pressure along the length of the Sniffer pipe relative to the space occupied by the foam insulation layer. Any gas leaked from the carrier pipe will be sucked into the Sniffer pipe and drawn downstream past the gas detector 16 which will provide an appropriate signal if leaked gas is detected.

It is understood that the above-described embodiments are merely illustrative of the possible specific embodiments which may represent principles of the present invention. Other arrangements may readily be devised in accordance with these principles by those skilled in the art without departing from the scope and spirit of the invention.

1. An integrated pipeline and gas leak detection system, comprising:
a. (a) pipeline comprising at least one integrated pipe section which comprises:
(i) a carrier pipe;
(ii) a tubular outer jacket surrounding said carrier pipe with an annular space defined between said outer jacket and said carrier pipe;
(iii) a gas leak detection pipe (“Sniffer pipe”) situated in said annular space generally parallel to said carrier pipe, said Sniffer pipe having a plurality of holes extending radially through its walls and axially spaced from each other, and
(iv) thermal insulation material in said annular space and surrounding said Sniffer pipe, with opposite ends of said annular space closed;
b. a suction device coupled to one end of said Sniffer pipe, the other end of said Sniffer pipe being closed, and
c. a gas detection device situated between said suction device and said Sniffer pipe, whereby operation of said suction device sucks any gas leaked from said carrier pipe in through said apertures in said Sniffer pipe, then through said Sniffer pipe to said gas detector which detects the presence of said leaked gas.

2. A system according to claim 1 wherein said pipeline comprises a plurality of said integrated pipe sections situated end-to-end, with adjacent ends joined together into a continuous conduit.

3. A system according to claim 1 wherein said pipeline has a diameter in the range of 20 mm to 1220 mm, and said apertures in said Sniffer pipe have diameter in the range of 2 mm to 4 mm.

4. A system according to claim 3 wherein said apertures are spaced apart axially at least 10 mm.

5. A system according to claim 3 wherein said Sniffer pipe comprises extruded plastic.

6. A system according to claim 5 wherein said plastic is selected from the group comprising cross-linked polyethylene, LDPE, MDPE and HDPE.

7. An integrated pipe section comprising:
a. a length of carrier pipe;
b. a tubular outer jacket surrounding said carrier pipe with an annular space defined between said outer jacket and said carrier pipe;
c. thermal insulation material in said annular space; and
d. a section of gas leak detection pipe (“Sniffer pipe”) situated in said insulating material in said annular space and lying generally parallel to said carrier pipe,
said Sniffer pipe having a plurality holes extending radially through its wall and axially spaced from each other.

8. An integrated pipe section according to claim 7 wherein said carrier pipe has radius R₁, said outer jacket has radius R₂, said annular space has radial thickness t, where t=R₂−R₁, and said Sniffer pipe has diameter D, where D is less than t.

9. An integrated pipe section according to claim 7 wherein said thermal insulation comprises pentane CO₂.

10. An integrated pipe section according to claim 7 wherein said Sniffer comprises perforated PEX.

11. An integrated pipe section according to claim 7 wherein said Sniffer pipe is surrounded by a layer of open-celled HDPE which allows diffusion therethrough of leaked gas.

12. A method of testing an integrated pipe section as defined in claim 7 and which has proximal and distal ends, comprising the steps:
a. closing the distal end of said Sniffer pipe,
b. applying a positive pressure of 0.1 to 8 bars to said proximal end, and
c. measuring any drop in pressure in said Sniffer pipe.

13. A method of manufacturing an integrated pipe section as defined in claim 7 comprising the steps:
a. positioning a carrier pipe within a tubular outer jacket, thereby defining an annular space between them,
b. applying a layer of HDPE foil tightly around said Sniffer pipe's circumferential outer surface,
c. positioning said foil-covered Sniffer pipe in said annular space lying generally parallel to said carrier pipe, and
d. filling said annular space, except for the part occupied by said Sniffer pipe, with foamed-in thermal insulation material.

14. A method according to claim 13 comprising the further step of sealing the opposite ends of said insulation material.

15. A method of providing a detection system for a leak of gas from a carrier pipe through which gas is being conveyed, where said carrier pipe is surrounded by an annular layer of thermal insulation and an outer jacket surrounding said annular layer, comprising the steps:
a. providing a gas leakage detection pipe (“Sniffer”) pipe having apertures extending radially through its walls and distributed along its length,
b. positioning said Sniffer pipe in said annular space, generally parallel to said carrier pipe, and surrounded by said insulation material, and
c. sealing the ends of said insulation material.
said Sniffer pipe apertures being configured to allow passage therethrough of any gas leaked from said carrier pipe.

16. A method according to claim 15 wherein said insulation material is foamed-in, comprising the further step of surrounding the outer circumferential surface of said Sniffer pipe with open-celled HDPE foil before said insulation material is foamed into said annular space.

17. An integrated-pipeline and gas leak detection system, comprising:
a. (a) pipeline comprising at least one integrated pipe section which comprises:
(i) a carrier pipe;
(ii) a tubular outer jacket surrounding said carrier pipe with an annular space defined between said outer jacket and said carrier pipe; and
(iii) a gas leak detection pipe (“Sniffer pipe”) situated in said annular space generally parallel to said carrier pipe, said Sniffer pipe having a plurality of holes extending through its walls and axially spaced from each other,
b. a suction device coupled to said Sniffer pipe, and
c. a gas detection device situated between said suction device and said Sniffer pipe, whereby operation of said suction device sucks gas leaked from said carrier pipe in through said apertures in said Sniffer pipe, then through said Sniffer pipe to said gas detector which detects the presence of said leaked gas.

18. An integrated pipe section comprising:
a. a length of carrier pipe;
b. a tubular outer jacket surrounding said carrier pipe with an annular space defined between said outer jacket and said carrier pipe;
c. a section of gas leak detection pipe (“Sniffer pipe”) situated in said annular space and lying generally parallel to said carrier pipe,
said Sniffer pipe having a plurality holes extending through its wall and axially spaced from each other.

19. An integrated pipeline and gas leak detection system, comprising:
a. (a) pipeline comprising at least one integrated pipe section which comprises:
(i) a carrier pipe;
(ii) a tubular outer jacket surrounding said carrier pipe with an annular space defined between said outer jacket and said carrier pipe;
(iii) a gas leak detection pipe (“Sniffer pipe”) situated in said annular space generally parallel to said carrier pipe, said Sniffer pipe having walls which define a bore therethrough and opposite ends, and a plurality of holes extending radially through said walls and axially spaced from each other, and
(iv) thermal insulation material in said annular space and surrounding said Sniffer pipe, with opposite ends of said annular space closed;
b. a suction device communicating with said bore of said Sniffer pipe, said opposite ends of said Sniffer pipe being closed, and
c. a gas detection device situated between said suction device and said bore of said Sniffer pipe, whereby operation of said suction device sucks any gas leaked from said carrier pipe in through said apertures in said Sniffer pipe, then through said Sniffer pipe to said gas detector which detects the presence of said leaked gas.
